(19) United States
(12) Patent Application Publication
(10) Pub. No.: US 2012/0292126 A1
(43) Pub. Date: Nov. 22, 2012

(54) METHOD FOR PROCESSING A SURFACE ELEMENT

(75) Inventor: Werner BECK, Weyhe (DE)

(73) Assignee: FORMTECH GMBH, Weyhe (DE)

(21) Appl. No.: 13/451,634

(22) Filed: Apr. 20, 2012

(30) Foreign Application Priority Data
May 19, 2011 (DE) 10 2011 102 087.3

(51) Int. Cl. F02K 1/82; B23K 31/02; B21D 26/021

(52) U.S. Cl. 181/213; 72/60; 228/173.6

(57) ABSTRACT

A method for processing at least one surface element wherein at least one layer of a deformable, medium-tight material is respectively attached to each side of the surface element, inserts the surface element and attached deformable layers between at least two molding tool parts and applies a pressure to at least one area of a surface section of the inserted surface element in response to a predetermined shaping temperature by introducing a medium between one of the deformable layers and a first molding tool part. The pressure acts directly against the deformable layer so that the surface element together with the deformable layers is shaped into at least one adjacent cavity of a second molding tool part due to the pressure created. A possibility of molding surface elements, which can currently not be shaped via gas pressure, into complex geometries, namely into spatially bent geometries, is created with this method.

### CROSS REFERENCE TO RELATED APPLICATIONS

Applicant claims priority under 35 U.S.C. §119 of German Application No. 10 2011 102 087.3 filed May 19, 2011, the disclosure of which is incorporated by reference.

### BACKGROUND OF THE INVENTION

1. Field of the Invention

The invention relates to a method for processing at least one surface element, in particular a surface element encompassing apertures, to a device for carrying out the method as well as to a sound insulation for lining an aircraft engine produced by means of the method.

2. Description of the Related Art

Surface elements, in particular made of metallic materials, can often be shaped to a limited extent by means of the known processing methods and as a function of the material characteristics. On principle, only hot shaping methods are suitable for the shaping of high-strength materials, such as titanium alloys, for example, wherein those materials, in the case of which pressure is applied to the material to be shaped by means of a medium, are preferred in particular for small quantities. These hot shaping methods comprising a pressure-generating medium are also identified as superplastic shaping methods and provide for complex, namely spatially bent workpiece geometries, which cannot be produced by means of other methods or at least not economically.

A material, which is to be processed in this manner, for example a titanium alloy, is heated to a certain shaping temperature and encompasses an extremely low flow stress as well as a very high capability to change shape in response to very low shaping speeds. The capability to change shapes is thereby several hundred percent to above a thousand percent.

However, only few materials encompass superplastic shaping characteristics, so that these processing methods can only be used in the case of certain materials. In addition, surface elements encompassing apertures cannot be shaped, because they are not medium-tight, that is, a shaping pressure cannot be built up by means of the medium.

Areas of applications for superplastically deformed workpieces comprising complex, spatially bent geometries, mainly lie in the body constructions and in the aerospace industry, so as to provide space-saving or aerodynamically advantageous constructions, for example. In some areas, such as the engine development for aviation, for example, the use of surface elements comprising apertures is required additionally, so as to attain noise emissions, which are as low as possible. The explored or used surface elements, respectively, for reducing the noise emissions are thereby often based on the Helmholtz-Resonator principle. The materials required for this are preferably high-strength and heat-resistant titanium materials and/or other metallic alloys. The components produced therewith disadvantageously encompass only simple workpiece geometries and are only embodied cylindrically or in a cone-shaped manner. In the alternative, the surface elements consist of nickel-base materials, high-strength steels or pure titanium, wherein nickel-base materials and steel materials comprising a high specific weight and pure titanium comprising a low stability in each case encompass a decisive disadvantage as compared to titanium alloys.

Aerodynamically advantageous and space-saving workpiece geometries comprising a high stability, in the case of which the known disadvantages are avoided, are currently not possible.

### SUMMARY OF THE INVENTION

The invention is now based on the object of providing a method, which makes it possible to process surface elements, which can currently not be shaped superplastically, in particular surface elements encompassing apertures, so as to produce spatially bent sound insulations for aircraft engines, among others.

This object is solved by the method and device according to the invention. Further developments and advantageous embodiments of the invention are discussed below.

In the case of the method for processing at least one surface element, in particular a surface element encompassing apertures, according to the invention at least one layer of a deformable, medium-tight material is in each case attached to both sides of the surface element, the surface element together with the deformable layers is inserted between at least two molding tool parts and pressure is applied to at least one area of a surface section of the inserted surface element in response to a predetermined shaping temperature by introducing a medium between one of the deformable layers and a first molding tool part, wherein the pressure acts directly against the deformable layer, and the surface element together with the deformable layers is shaped into at least one adjacent cavity of a second molding tool part by means of the pressure, which is created.

By means of the deformable layers, which are attached to both sides of the surface element, it is also possible to process materials, which cannot be shaped superplastically or only poorly, respectively, by means of the known, conventional methods. Surface elements encompassing apertures on the one hand and medium-tight surface elements on the other hand, which consist of materials, which encompass only partially suitable shaping characteristics, can thus be pressed into complex, spatially bent workpiece geometries, which are not possible without a holding-down function of the deformable layers in a simple manner and with high precision. The surface element, which is to actually be shaped, is thereby held between the deformable layers, wherein it can move relatively in a space, which is defined by the distance of the deformable layers relative to one another, in response to the shaping.

During the shaping, the medium, which has been introduced, presses directly against a first one of the two deformable layers, indirectly against the surface element, from which the workpiece or the component, respectively, is shaped, via the first deformable layer, and also against a second deformable layer via the surface element. A direction is thus provided to the flow behavior of the actual workpiece by means of the deformable layers. As soon as the material, which is to be processed, together with the deformable layers rests holohedrally against the contour of the wall of the adjacent cavity of the second molding tool part, the shaping process is complete. The surface element can then be removed from the molding tool parts together with the deformed layers. After the cool-down, the surface element is then removed from the envelope of the deformable layers.

The layers of deformable, medium-tight material, which are shaped together with the workpiece, are only an auxiliary means for the shaping and must be discarded in most cases. A multiple use is not or at least not economically possible due to the material of the deformable layers, which is to be used preferably. The deformable layer must thus be considered to be a “lost part” or expendable item, respectively.

Advantageously, the deformable layers, which are used for a shaping, consist of a material comprising a low value and a satisfactory hot shaping behavior. Sheet material, in particular made of micro-duplex ferrous alloys, is suitable, for example. In other embodiments, however, other high temperature-resistant, deformable, medium-tight materials can also be used. Magnesium at temperatures of up to approx. 380° C., aluminum up to approx. 480° C., titanium up to 700° C. or 900° C., respectively, steel up to approx. 1100° C. are possible. Due to the fact that the deformable layers, which are made of one material, deform similarly and the workpiece can move relative between the layers and is not stretched, the distance between them remains the same in response to the shaping, whereby workpieces having virtually the same wall thickness can be ensured, which are not highly stretch-formed and which also do not encompass any thinning in the material strength. This advantage exists in particular also in the case of medium-tight surface elements comprising a closed surface.

In contrast, the surface element, which is to be processed, must not necessarily also encompass superplastic shaping characteristics, because it is “positively guided” due to the deformation of the layers, which abut. A further advantage is that the surface element, which is to be processed, can encompass apertures, so that surface elements comprising mesh, screen, hole or netting structures can also be shaped. Preferably, the surface element is made of a metallic material, such as ferrous or titanium alloys, wherein a particular interest lies in the shaping of titanium aluminides. They can thereby be inserted between the deformable layers as film or as thin sheet plate as well as a thicker disk. In addition to metallic materials, the surface element, which is to be shaped, can however also consist of carbon fiber reinforced plastic or other composite materials, for example, when they encompass a thermoplastic matrix.

If it is fixed between the deformable layers, the cut of the surface element can be smaller, because an edge is not required for clamping the surface element between the molded tool parts. For this purpose, the deformable layers advantageously encompass an edge area projecting around the cut of the surface element. Between the molding tool parts, only the edge areas of the deformable layers are then held in a clamping area, so that the surface element, which is fixed between the layers, is positioned optimally for the shaping, that is, without material losses. Due to the smaller cut of the surface element, the costs in response to the shaping of surface elements comprising apertures as well as in the case of medium-tight surface elements can be lowered, because the material of the surface element considerably exceeds the value of the deformable layers for the most part and is thus decisive for the costs, which are incurred in response to carrying out the method.

A gas is mostly used as pressure-generating medium. Advantageously, the medium, which is used, is an inert protective gas, such as argon or nitrogen, for example, so as to avoid undesired reactions.

Prior to the insertion between the molding tool parts, the surface element can be pre-heated together with the deformable layers, so as to shorten the time, which is required for the actual shaping process. To heat the molding tool parts comprising the surface element, which is to be shaped, and the deformable layers to the predetermined shaping temperature, they are preferably inserted into a heating press. The deformation of the surface elements, which are arranged between the molding tool parts, then takes place in the heating press.

So that the deformable layers and the surface section, which in each case abuts on the deformable layers, do not adhere to one another in response to the temperatures, which are high for the most part, a separating agent is to be applied at least between one surface section of the surface element and a respective assigned deformable layer. Said separating agent has the effect that the surface element and the deformable layer can be separated easily after the cool-down. Graphite and boron nitride as well as Yttrium can first and foremost be used as separating agents. Preferably, such separating agents must also be applied in the areas, in which the workplace or the deformable layers abut on the molding tool parts, in particular the wall of the cavity, so as to avoid a “fusing” here as well. The separating agents can be sprayed onto the surfaces in liquid form, for example, or can also be inserted as graphite film or graphite plate.

According to a further development of the method, provision is made for at least two surface elements to be inserted together between the molding tool parts and to be shaped. In the event that they are separated from one another by means of at least one deformable layer, a plurality of workplaces can be made simultaneously in one shaping process. An alternative for a deformable layer could also be a layer of a separating agent, which is applied between the surface elements.

In the event that a deformable layer and a separating agent is not inserted or applied, respectively, between two surface elements, which are arranged so as to be located next to one another, the at least two surface elements can be connected to one another by means of diffusion welding. The shaping as well as the diffusion welding are thereby preferably combined with one another in a production cycle of a workpiece, wherein either the diffusion welding is carried out first and then the shaping or the shaping is carried out first and the diffusion welding is carried out thereafter. The connection by means of diffusion welding is attained by means of the bounding surface diffusion of the respective bounding surfaces to one another and provides the opportunity to embody a holohedral connection of the surface elements. Temperatures of above 900° C., a specific contact pressure as well as a certain dwell time, for example, are required for titanium alloys in response to diffusion welding.

The diffusion welding of the surface elements thereby takes place in particular under protective gas, so as to prevent impacts caused by ambient air or other entering gases, such as oxygen, for example. In the case of multi-layer surface elements, at least one of which encompasses apertures in sections, the latter can be shaped to form complex geometries. Surface elements, which encompass a plurality of apertures, can advantageously be connected to one another holohedrally and can thus satisfy the highest stability demands. One area of application for such a holohedrally welded compound could be a combination of perforated plate and mesh or screen or netting structures, respectively, as they are explored and used to lower noise emissions of aircraft engines. In the case of the combination of a surface element encompassing apertures with a surface element without apertures, a surface structure can additionally be designed such that the closed surface of the one surface element with the surface element, which encompasses apertures, is increased. A structured surface comprising a plurality of recesses is thus created on the side of the workpiece, at which the surface element comprising the apertures is arranged. A geometric locking of other surfaces or components, respectively, is then possible at this structured surface. An improvement of the load transmission of adhesive constructions can be attained by means of geometric locking.

In the alternative, provision is made for a surface structure to be stamped into at least one surface section of a surface element, so as to ensure reliable adhesive connections to other workpieces. The stamped patterns can thereby be designed freely for the most part and can be incorporated into one of the deformable layers or the wall of the cavity, respectively, into which the surface element is molded. Internal stresses are thereby not created in the material of the workpiece, as is also the case in response to the diffusion welding.

In addition, the invention comprises a device for processing at least one surface element encompassing apertures, by means of at least two molding tool parts, between which at least one accommodating area for at least one surface element is arranged, wherein at least a first molding tool part encompasses a medium line, which leads to the accommodating area and which comprises an inlet opening for a medium, to which pressure can be applied, and at least one cavity, which is adjacent to the accommodating area, is at least embodied in a second molding tool part. This device is characterized in that at least one layer consisting of deformable, medium-tight material is in each case assigned to the first molding tool part and to the second molding tool part, which define the accommodating area for the surface element to the first molding tool part and to the second molding tool part and which can be inserted between the at least one surface element, which is to be shaped.

A first one of the deformable layers is thereby preferably arranged such that the area, into which a medium is introduced via the inlet opening, is sealed towards a surface element, which is inserted in the accommodating area. It is ensured through this that a pressure, which indirectly also pushes against the surface element, which is arranged so as to abut on the first deformable layer and a second deformable layer, can be built up between the first deformable layer and the first molding tool part. The surface element deforms under the pressure together with the deformable layers until it completely rests abuts on the inner wall of the cavity of the second molding tool part. With the second deformable layer, the surface element can additionally encompass a cut, which is as small as possible, of the material, which is expensive for the most part. Advantageously, the deformable layers then encompass an edge area, which projects around the dimensions of the surface element. Only the deformable layers can be inserted into a clamping area of the molding tool parts with the projecting edge area, whereby a surface element, which is inserted into the accommodating area, is only fixed between the deformable layers and does not project into the clamping area of the molding tool parts due to the dimensions, which are lower at least around the clampable edge area.

Creases, which possibly appear during the shaping, are additionally avoided in the case of a surface element, which is fixed between two deformable layers, and the result is that the shaped workpiece has virtually the same wall thickness. A sufficient flow behavior of the material of the surface element, which, has been heated to shaping temperature, is nonetheless ensured between the deformable layers.

So that the gas, which is contained in the cavity into which the surface element can be molded, at least one degassing opening is assigned to the inner wall of the cavity. In response to the shaping under protective gas or vacuum, the degassing opening as well as the medium line are advantageously assigned to a system, which is closed to the environment, so as to eliminate undesired gases in response to the method and so as to provide for an economical use of the protective gas.

So as to heat the surface element, which is inserted between the molding tool parts, to the shaping temperature, provision is made for the molding tools to be assigned to a heating press and that they are heated to the shaping temperature in said heating press. As an alternative to a heating press, at least one of the molding tool parts can advantageously encompass at least one heating element. For an improved heat distribution and heat utilization, both molding tool parts should then encompass one or a plurality of heating elements, respectively, so as to create a correspondingly optimized arrangement of the heating elements.

Sound insulations for lining aircraft engines etc., among others, can then be manufactured by means of the afore-mentioned method or the device, respectively. They encompass at least one surface element encompassing apertures and are characterized according to the invention in that the surface element encompasses a spatially bent geometry, which cannot be unwound and that the surface element is embodied from high-strength, heat-resistant material.

The spatially bent geometry, which cannot be unwound, of the surface element is to be understood herein, for example, as a curved structure, which is embodied as a half-pipe, for example, in the embodiment as a sound insulation for an aircraft. The half-pipe encompasses an approximately cylindrical section and a second section, which is attached to a slightly widened end area of the cylindrical section and which is curved outwardly relative to the cylindrical section. Two of these half-pipes preferably form the sound insulation of an engine, wherein the air flows or exhaust gases, respectively, which cause noise emissions, flow towards the sound insulation. By means of a surface structure, which is arranged so as to face the respective air or exhaust gas flow, respectively, of surface elements comprising apertures, in particular a combination of perforated plates and/or mesh or screen or netting structures, respectively, the resulting noise emissions are reduced on the basis of the Helmholtz-Resonator principle. In tests, it was possible to reduce the noise emissions by more than 4 dB, for example. Depending on the design of the engine or of the sound insulation, respectively, the surface elements comprising the perforated plates and/or the structures can be arranged at the concave inner wall and/or at the convex outer wall. In the case of only one surface element comprising a perforated plate/mesh structure, the second wall must be embodied as a closed surface.

Preferably, the individual layers of the surface element consisting of perforated plate and/or mesh structure are connected to one another across the entire adjoining bounding surface by means of diffusion welding. A particularly solid connection of perforated plate and mesh structure, which satisfies the high demands, can be attained through this. As material for the sound insulation, provision is advantageously made for the high-strength, heat-resistant material of the surface element to be a titanium alloy or titanium aluminum alloy. It encompasses a high stability while simultaneously having good weight characteristics and a high thermal stability.

### BRIEF DESCRIPTION OF THE DRAWINGS

An exemplary embodiment of the invention, from which further inventive features follow, is illustrated in the drawing.

FIG. 1 shows a cross section through a schematic illustration of a device according to the invention comprising an unprocessed surface element;

FIG. 2 shows the schematic illustration of the device in cross section comprising the shaped surface element;

FIG. 3 shows a cross section through a section of a diffusion-welded surface element and

FIG. 4 shows a sound insulation for an engine of an aircraft in a perspective view.

### DETAILED DESCRIPTION OF THE PREFERRED EMBODIMENT

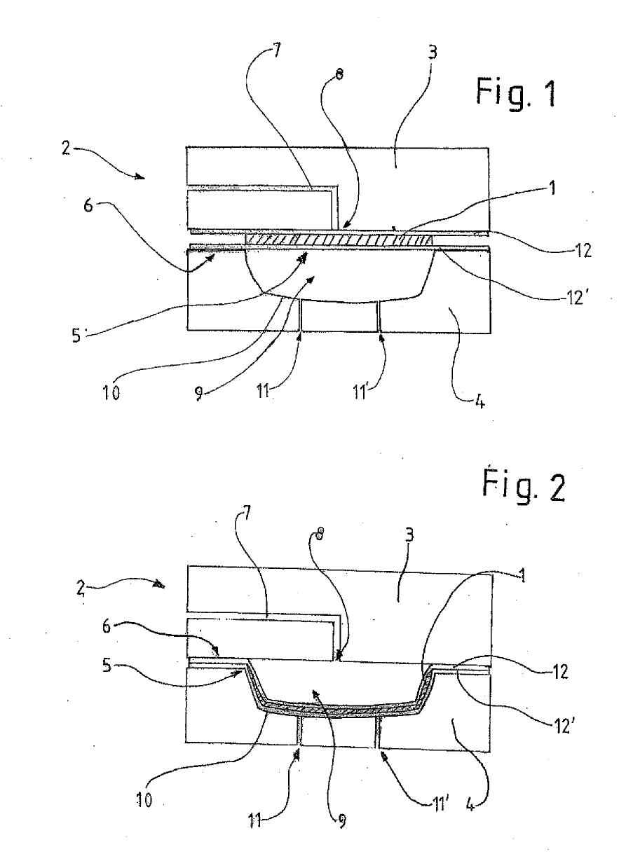

FIG. 1 and FIG. 2 in each case show a method step of shaping a surface element 1 encompassing apertures by means of a device 2. This device 2 encompasses a first molding tool part 3 and a second molding tool part 4. An accommodating area 5 for a surface element 1 is arranged between the molding tool parts 3, 4. A clamping area 6 is arranged around the accommodating area 5 between the molding tool parts 3, 4. The first molding tool part 3 encompasses a medium line 7, which ends in an inlet opening 8, which is directed towards the accommodating area 5. A cavity 9, the wall 10 of which encompasses the contour of the workpiece, which is to be molded from the surface element 1, is embodied in the second molding tool part 4. In addition, degassing openings 11, 11′ are assigned to the cavity 9.

In FIG. 1, a surface element 1 is held in the accommodating area 5 between two deformable layers 12, 12′, wherein the deformable layers 12, 12′ encompass a larger cut than the surface element 1 and they project into the clamping area 6 with their outer edge at the respective opposite sections. In its dimensions, the surface element 1 corresponds to those of the cavity 9.

In FIG. 2, the surface element 1 from FIG. 1, which is held between the molding tool parts 3, 4, is shaped together with the deformable layers 12, 12′ and abuts on the wall 10 of the cavity 9 while being surrounded by the deformable layers.

During the shaping, the two molding tool parts 3, 4 are pressed against one another so as to be sealed outwardly and medium is pressed between the first molding tool part 3 and the deformable layer 12 via the medium line 7 as well as the inlet opening B. The deformable layer 12, to which pressure can be applied, is deformed through this such that the latter is molded into the cavity 9 together with the surface element 1 and the deformable layer 12′ until the deformable layer 12′ completely abuts on the wall 10 and a further deformation is not possible. Gas, which is contained in the cavity 9, can escape completely via the degassing openings 11, 11′. By opening the molding tool parts 3, 4, the surface element 1 can be removed from the molding tool parts 3, 4 together with the deformable layers 12, 12′ after the shaping. After the surface element 1 and the deformable layers 12, 12′ have cooled down, the surface element 1 and the deformable layers 12, 12′ are separated from one another. The finished surface element 1 can then be supplied to a further processing.

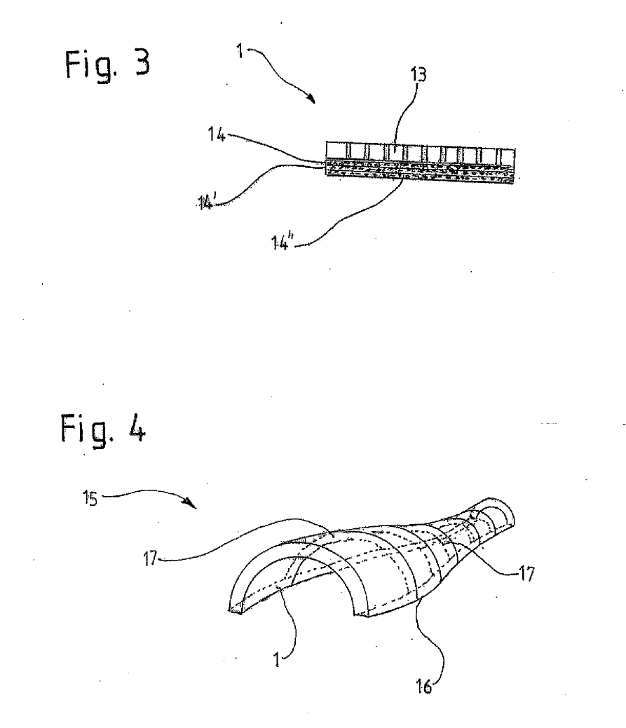

In FIG. 3, a cross section through a multi-layer surface element 1 is shown. It consists of a layer of perforated plate 13 and of three layers comprising a mesh structure 14, 14′, 14″, which are in each case connected to one another holohedrally by means of diffusion welding at the bounding surfaces between the adjacent layers 13, 14, 14′, 14″.

FIG. 4 shows a sound insulation 15 for an aircraft engine, which is manufactured according to the method according to the invention and which encompasses a surface element 1, which is designed according to FIG. 3, as well as a further surface element 16 of sheet plate, wherein the surface element 1 or 16, respectively, comprising apertures would be arranged at the inner wall or the outer wall. The sound insulation 15 thereby encompasses a geometry, which is embodied as a half-pipe and which encompasses an approximately cylindrical first section as well as a second section, which is attached to a wider end area of the first section and which is curved outwardly. The surface elements 1 and 16 are spaced apart from one another across the entire geometry at substantially the same distance. This distance is predetermined by reinforcement structures 17, which are arranged between the surface elements 1 and 16.

What is claimed is:

1. A method for processing at least one surface element (1), in particular a surface element (1) encompassing apertures, in the case of which at least one layer (12, 12′) of a deformable, medium-tight material is in each case attached to the surface element (1) on both sides,
the surface element (1) together with the deformable layers (12, 12′) is inserted between at least two molding tool parts (3, 4),
a pressure is applied to at least one area of a surface section of the inserted surface element (1) in response to a predetermined shaping temperature by introducing a medium between one of the deformable layers (12) and a first molding tool part (3), wherein the pressure acts directly against the deformable layer (12), and
the surface element (1) together with the deformable layers (12, 12′) is shaped into at least one adjacent cavity (9) of a second molding tool part (4) by means of the pressure, which is created.

2. The method according to claim 1, wherein the deformable layers (12, 12′) are clamped between the molding tool parts (3, 4) with an edge area, which projects around the surface element (1).

3. The method according to claim 1, wherein the medium is a protective gas.

4. The method according to claim 1, wherein the surface element (1) is preheated prior to the insertion between the molding tool parts (3, 4).

5. The method according to claim 1, wherein the molding tool parts (3, 4) comprising the surface element (1) and the deformable layers (12, 12′) are inserted into a heating press and are heated therein to the predetermined shaping temperature.

6. The method according to claim 1, wherein a separating agent is applied between at least one surface section of the surface element (1) and a respective assigned deformable layer (12, 12′).

7. The method according to claim 1, wherein at least two surface elements (1) are together inserted between the molding tool parts (3, 4) and are reshaped.

8. The method according to claim 1, wherein at least two surface elements (1) are connected to one another by means of diffusion welding.

9. The method according to claim 8, wherein a structured surface is created by means of a surface element, which encompasses a hole, a screen or a netting structure.

10. The method according to claim 1, wherein a surface structure is stamped into at least one surface section of a surface element (1).

11. A device for processing at least one surface element encompassing apertures, comprising at least two molding tool parts, between which at least one accommodating area for at least one surface element is arranged, wherein at least a first molding tool part encompasses at least one medium line, which leads to the accommodating area, comprising at least one inlet opening for a medium, to which pressure can be applied, and at least one cavity, which is adjacent to the accommodating area, is embodied in at least a second molding tool part,
wherein at least one layer (12) of a deformable, medium-tight material is in each case assigned to the first molding tool part (3) and to the second molding tool part (4), which define the accommodating area (5) for the at least one surface element (1) to the first molding tool part (3) and to the second molding tool part (4) and between which the at least one surface element (1) can be inserted.

12. The device according to claim 11, wherein the deformable layers (12, 12′) encompass an edge area, which projects around the dimensions of the surface element (1).

13. The device according to claim 11, wherein the molding tool parts (3, 4) are assigned to a heating press.

14. The device according to claim 11, wherein at least one of the molding tool parts (3, 4) encompasses at least one heating element.

15. A sound insulation for lining an aircraft engine, which is manufactured in particular by means of the method according to claim 1 and comprising a device for processing at least one surface element encompassing apertures, said device comprising at least two molding tool parts, between which at least one accommodating area for at least one surface element is arranged, wherein at least a first molding tool part encompasses at least one medium line, which leads to the accommodating area, comprising at least one inlet opening for a medium, to which pressure can be applied, and at least one cavity, which is adjacent to the accommodating area, is embodied in at least a second molding tool part, wherein at least one layer (12) of a deformable, medium-tight material is in each case assigned to the first molding tool part (3) and to the second molding tool part (4), which define the accommodating area (5) for the at least one surface element (1) to the first molding tool part (3) and to the second molding tool part (4) and between which the at least one surface element (1) can be inserted, said sound insulation comprising at least one surface element, which encompasses apertures,
wherein the surface element (1, 16) encompasses a spatially bent geometry, which cannot be unwound and
wherein the surface element (1, 16) is embodied of a high-strength, heat-resistant material.

16. The sound insulation according to claim 15, wherein the surface element (1, 16) encompasses a combination of at least one perforated plate (13) and at least one mesh structure (14, 14′ 14″), wherein the perforated plate (13) and the mesh structure (14, 14′, 14″) are connected to one another across the entire adjacent bounding surface.

17. The sound insulation according to claim 15, wherein the surface element (1, 16) consists of a heat-resistant material.

18. The sound insulation according to claim 15, wherein the high-strength, heat-resistant material of the surface element (1, 16) is a titanium alloy or a titanium aluminide alloy.

19. A method for processing at least one surface element comprising the steps of:
(a) providing a surface element having first and second sides and first and second deformable layers of a deformable, medium-tight material attached to the first and second sides, respectively;
(b) inserting the surface element together with the first and second deformable layers is inserted between at least first and second molding tool parts;
(c) introducing a medium between the first deformable layer and the first molding part to apply a pressure to at least one area of a surface section of the surface element following insertion in response to a predetermined shaping temperature, wherein the pressure acts directly against the first deformable layer;
(d) shaping via the pressure created the surface element together with the first and second deformable layers into at least one adjacent cavity of the second molding tool part; and
(e) clamping with an edge area projecting around the surface element the first and second deformable layers between the first and second molding tool parts.
